(19) United States
(12) Patent Application Publication
(10) Pub. No.: US 2008/0141570 A1
(43) Pub. Date: Jun. 19, 2008

(54) Thermoplastic elastomer protective louver covering for use with an electronic display module

(75) Inventors: Nathan Lane Nearman, Brookings, SD (US); Jay DeBlonk, Volga, SD (US)

Correspondence Address: HUGH D JAEGER, P.A., P.O. BOX 672, WAYZATA, MN, 55391-0672, US

(73) Assignee: Daktronics, Inc.

(21) Appl. No.: 11/589,405

(22) Filed: Oct. 30, 2006

(51) Int. Cl. G09F 13/04

(52) U.S. Cl. 40/574

(57) ABSTRACT

A thermoplastic elastomer protective louver covering for use with an electronic display module for the protection of persons coming into inadvertent contact with an electronic display module incorporating the thermoplastic elastomer protective louver covering and for protection of the electronic display module incorporating the thermoplastic elastomer protective louver covering. The resilient, flexible and energy absorbent thermoplastic elastomer protective louver covering is overmolded to the louvers of an electronic display module at a suitable protection thickness exceeding the depth of the exposed louver components to protectively cover up any sharp, pointed or other player-damaging shapes of the louver panel.

### CROSS REFERENCES TO RELATED APPLICATIONS

This application is related to U.S. utility patent application Ser. No. 10/688,304 filed Oct. 17, 2003, entitled “Electronic Display Module Having a Four-Point Latching System for Incorporation into an Electronic Sign and Process”, which is now U.S. Pat. No. 7,055,271.

### BACKGROUND OF THE INVENTION

1. Field of the Invention

The present invention is for an electronic sign, but more precisely relates to a thermoplastic elastomer protective louver covering for use with an electronic display module for the protection of persons coming into inadvertent contact with an electronic display module incorporating the thermoplastic protective louver covering and for protection of the electronic display module itself.

2. Description of the Prior Art

Prior art electronic information displays incorporating electronic display modules are often placed in close physical proximity to a sporting event. A participating player in a sporting event who runs into the electronic display can possibly cause damage to himself or herself or to the electronic display module components. Electronic display modules often contain formed louver components extending outwardly to shade LEDs for better visual perception. When the louvers are contacted with force by a sports person, the louvers could puncture the players skin or otherwise cause injury to the player. Other damage may be incurred by errant sports equipment, such as a sports ball hitting the electronic display module. Measures were taken to overcome the shortcomings of prior art devices including the addition of a protective sheet of Plexiglass® or other like material across the entire face of multiple electronic display modules making up the forward portion of an electronic sign display. Heat and cold often compromised the use of Plexiglass®, wherein expansion and contraction with extreme heat or cold complicated the design. Plexiglass® sheet splices proved unsatisfactory in that players impinging an unsupported seam between adjacent Plexiglass® sheets could be injured. To counteract such an arrangement, sheets were overlapped, thereby creating an undesirable visual aberration. Additionally, Plexiglass® is reflective wherein light sources reflecting from the Plexiglass® surface could be distractive to the player or to a sports fan. The reflective problem was overcome somewhat by adding a matte coating to the Plexiglass® at the cost of reduced visual acuity. Often these or other additional remedial steps incurred additional production time and expense. What is needed is a protective device for use with an electronic display module in an electronic display which offers protection both for the electronic display module and the athlete, while maintaining good visual contrast, viewing angles, and overall appearance.

### SUMMARY OF THE INVENTION

The general purpose of the present invention is to provide a thermoplastic elastomer protective louver covering for use with an electronic display module.

According to one or more embodiments there is provided a thermoplastic elastomer protective louver covering, the present invention, shown in use with an electronic display module where the protective louver covering comprised of, but not limited to, thermoplastic elastomer, also known as TPE, is overmolded to the outermost surface of the electronic display module, i.e., to the exterior of the louver located at the forward portion of the electronic display module. A plurality of elongated holes, which are in the thermoplastic elastomer protective louver covering, allow components of an electronic display module including, but not limited to, a plurality of protruding louvers and a corresponding plurality of closely associated pixels comprised of groups of light emitting diodes (LEDs) extending therethrough, to be viewed unobstructed and unhampered. The thermoplastic elastomer protective louver covering is overmolded on the louver panel to a suitable depth of protection which is preferably at least thicker than the depth of the exposed louver panel components and covers up any sharp, pointed or other potentially player-damaging shapes of the louvers on the louver panel. The thermoplastic elastomer protective louver covering provides protection to points of contact between the player and the electronic display module because of the thickness and inherent properties of the thermoplastic elastomer which make the thermoplastic elastomer elastic and flexible and impact absorbent. The thermoplastic elastomer material is also resistant to abrasion and is suitable for use in a wide range of temperatures. The thermoplastic elastomer can be sized to the individual electronic display module and not to the overall size of an electronic sign display, thereby eliminating the need for large and unwieldy protective sheets. The thermoplastic elastomer protective louver covering is thusly located at the area where possible contact could occur between the players or sports items, such as a ball or other related items, and the electronic display modules. When player/panel impact does occur, the thermoplastic elastomer protective louver covering absorbs some of the energy so that the consequential impacting damages are reduced to both the player and the electronic display module. The thermoplastic elastomer protective louver covering can be suitably shaped to allow for maximum vertical and horizontal views of the LEDs comprising the LED pixels. The thermoplastic elastomer protective louver covering is shown in use and in intimate or near intimate contact with supporting and otherwise related and closely associated components of an electronic display module including, but not limited to, a louver panel, an LED display panel, and a housing.

One significant aspect and feature of the present invention is the use of a thermoplastic elastomer protective louver covering overmolded onto louvers and onto other features of the louver panel of an electronic display module.

Another significant aspect and feature of the present invention is a thermoplastic elastomer protective louver covering overmolded onto components of a louver panel to a suitable depth of protection which is preferably at least thicker than the depth of the exposed louver components to cover up any sharp, pointed or other potentially player-damaging shapes of the louver panel.

Another significant aspect and feature of the present invention is the use of a thermoplastic elastomer protective louver covering to space underlying components of the louver panel from the players to protect the players from collision injury.

Another significant aspect and feature of the present invention is the use of an impact absorbent thermoplastic elastomer protective louver covering to protect the structure of an electronic display module from impact injury caused by impact of a player or sport equipment.

Another significant aspect and feature of the present invention is the use of holes within the thermoplastic elastomer protective louver covering which accommodate the extension of light emitting diodes and extension of corresponding louvers of a louver panel therethrough to facilitate shaded, uncovered, unobstructed and unhampered viewing of the light emitting diodes.

Still another significant aspect and feature of the present invention is the use of protective protrusions extending from a planar base of the thermoplastic elastomer protective louver covering having angled geometrically configured shapes on the exterior exposed surface thereof, such as, but not limited to, opposed angled recesses having sculpted surfaces which allow viewing of light emitting diodes from the side at 70 degrees each side of the vertical centerline at maximum vertical and horizontal sighting views.

Still another significant aspect and feature of the present invention is the use spaces between rows of protective protrusions at the exterior exposed surface of the thermoplastic elastomer protective louver covering which allow viewing of light emitting diodes from the side at maximum vertical and horizontal sighting views.

Still another significant aspect and feature of the present invention is the use of a thermoplastic elastomer whereby heat or cold variations are of little consequence due to the elastic qualities of the thermoplastic elastomer protective louver covering.

Yet another significant aspect and feature of the present invention is the use of a thermoplastic elastomer which exhibits minimal reflection and can be painted to further improve contrast.

Having thus briefly described embodiments of the present invention and having mentioned some significant aspects and features of the present invention, it is the principal object of the present invention to provide a thermoplastic elastomer protective louver covering for use with an electronic display module.

### BRIEF DESCRIPTION OF THE DRAWINGS

Other objects of the present invention and many of the attendant advantages of the present invention will be readily appreciated as the same becomes better understood by reference to the following detailed description when considered in connection with the accompanying drawings, in which like reference numerals designate like parts throughout the figures thereof and wherein:

FIG. 1 is an isometric front view of a thermoplastic elastomer protective louver covering, the present invention, shown in use with an electronic display module;

FIG. 2 is an isometric front view of the thermoplastic elastomer protective louver covering and an exploded isometric front view of the electronic display module;

FIG. 3 is an isometric rear view of the electronic display module having a thermoplastic elastomer protective louver covering overmoldingly applied to the louver panel thereof;

FIG. 4 is an isometric rear view of the thermoplastic elastomer protective louver covering and an exploded isometric rear view of the electronic display module;

FIG. 5 is an isometric front view of a section of the thermoplastic elastomer protective louver covering showing the structure and geometrical configuration thereof;

FIG. 6 is an exploded isometric front view of the upper left corner of the thermoplastic elastomer protective louver covering, the corresponding upper left corner of the louver panel, and the corresponding upper left corner of the LED panel showing the alignment and relationship of the components thereof;

FIG. 7 is an isometric front view of the upper left corner of the thermoplastic elastomer protective louver covering in use with an electronic display module showing side view paths; and,

FIG. 8 is a cross section view along line 8-8 of FIG. 7 showing the thermoplastic elastomer protective louver covering, the present invention, incorporated into use with components of an electronic display module.

### DETAILED DESCRIPTION OF THE PREFERRED EMBODIMENTS

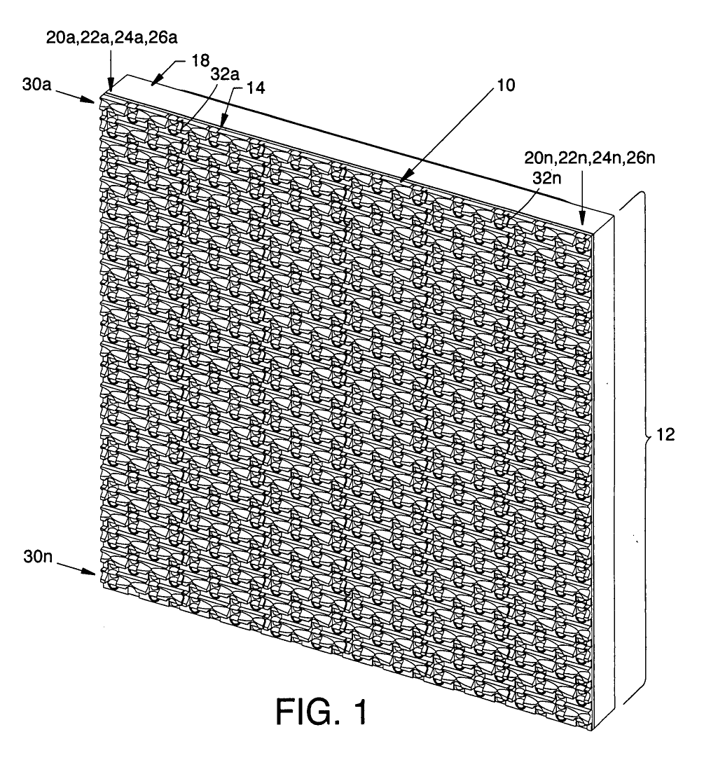

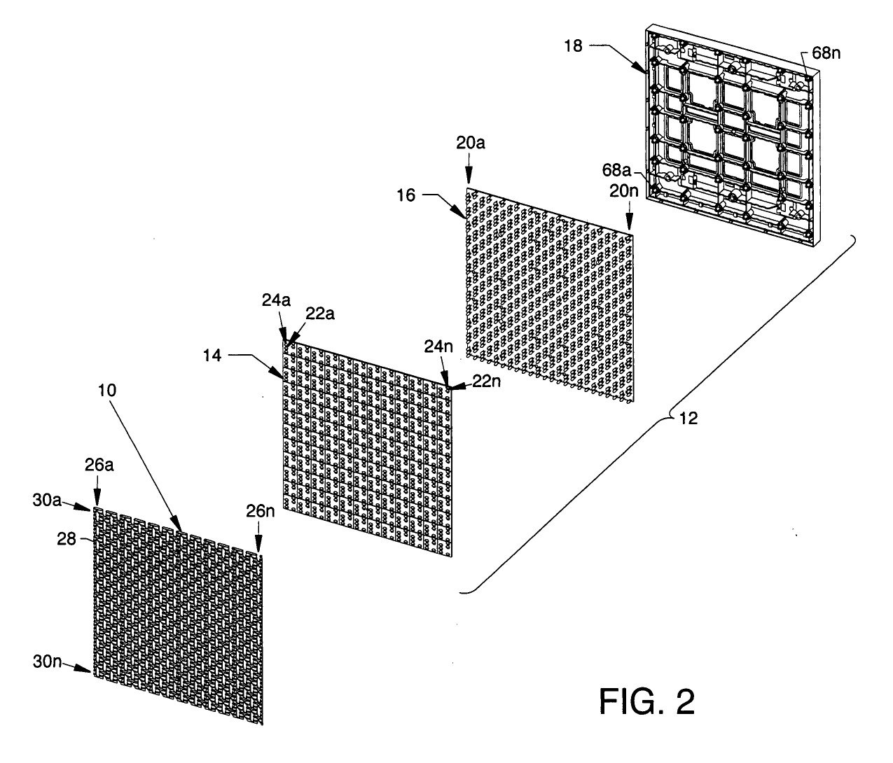

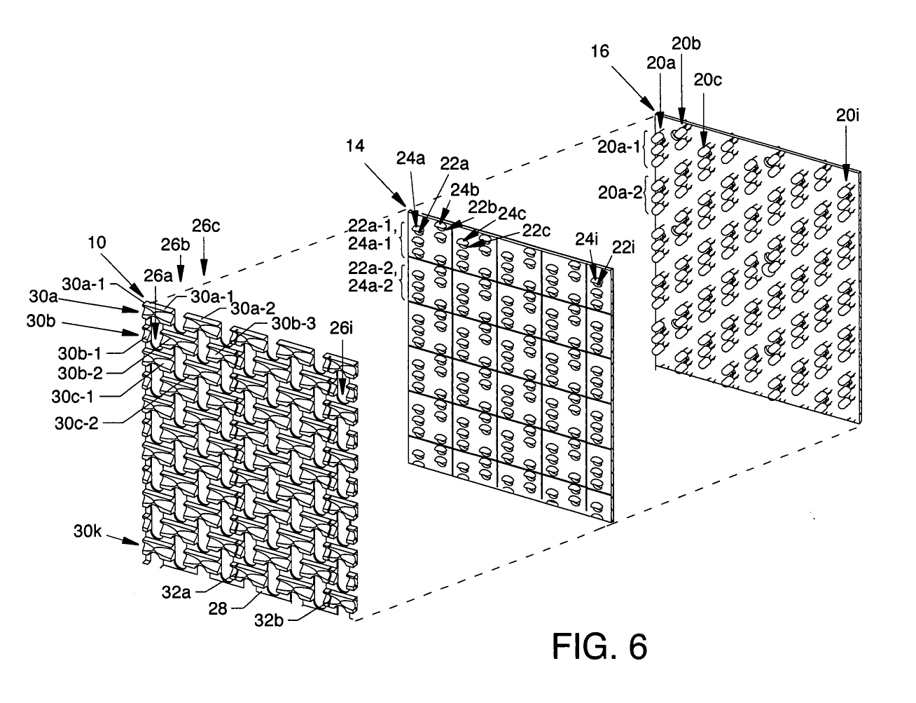

FIG. 1 is an isometric front view of a thermoplastic elastomer protective louver covering 10 for use with an electronic display module, the present invention, hereinafter, for brevity, referred to as the protective louver covering 10, shown in use with an electronic display module 12, and FIG. 2 is an isometric front view of the protective louver covering 10 and an exploded isometric front view of the electronic display module 12. Shown partially or fully in either or both of the figures is the geometrically configured protective louver covering 10 which, in practice, is overmolded over and to a louver panel 14 of an electronic display module, such as represented by an electronic display module 12, comprised of a louver panel 14, a light emitting diode (LED) panel 16, and a geometrically configured housing 18 incorporated by reference to U.S. Pat. No. 7,055,271 entitled “Electronic Display Module Having a Four-Point Latching System for Incorporation into an Electronic Sign and Process”, which has latching structure for fastening of the housing 18 and additional closely associated structure attached thereto to the structure of an electronic sign display. Understanding of the present invention is facilitated by understanding of the structure of an electronic display module, such as the representative electronic display module 12, also described herein, to which the protective louver covering 10 is overmolded. Overmolding is the process where two parts, a substrate and an overmold, are joined together to make a final product. In the invention, the substrate is the louver panel 14 which is made in a first injection mold tool and which consists of hard and rigid plastic. The louver panel 14 is removed from the first injection mold tool and then placed in a second mold, i.e., an overmold tool, where opaque thermoplastic elastomer (TPE) material, such as Versaflex made by The GLS Corp. of McHenry, Ill., or other suitable material, such as, but not limited to, Tekbond by Teknor Apex of Pawtucket, R.I., is applied by injection molding to form the protective louver covering 10 which forms a chemical bond with the louver panel 14. The overmold tool is cut to precisely fit the louver panel 14 in it, i.e., the substrate, and allow for application of TPE overmold material, i.e., the overmold therein. The overmold and the substrate, i.e., the thermoplastic elastomer of the louver covering 10 and the louver panel 14, form a chemical bond at their surface interface. The specified temperature range for suitable exposure and use of the thermoplastic elastomer including player protective impact resistance, flexibility, and abrasion resistance forming the protective louver covering 10 is 120° F. to −20° F. As shown in FIG. 2 and as shown more explicitly in other figures, the LED panel 16 includes sets of three vertically aligned and grouped LEDs forming a plurality of vertically arranged LED pixel columns 20a-20n, further designated and referred to in FIG. 6, having suffixes to indicate individual LED pixels, whereby the first LED pixel in the LED pixel column 20a would be pixel 20a-1, the second LED pixel in the LED pixel column 20a would be pixel 20a-2, and so on until reaching LED pixel 20a-n. The LED pixels of LED pixel columns 20a-20n extend through corresponding multiple columnar arrangements of three vertically aligned holes in hole group columns 22a-22n of the louver panel 14. The hole group columns 22a-22n are further designated and referred to in FIG. 6 having suffixes to indicate hole groups, whereby the first hole group in the hole group column 22a would be hole group 22a-1, the second hole group in the hole group column 22a would be hole group 22a-2, and so on until reaching hole group 22a-n. Each hole group column 22a-22n of the louver panel 14 is closely associated with corresponding multiple columnar arrangements having three vertical louvers aligned in louver group columns 24a-24n of the louver panel 14. The louver groups of the louver group columns 24a-24n are further designated and referred to in FIG. 6 having suffixes to indicate individual louver groups, whereby the first louver group in the louver group column 24a would be louver group 24a-1, the second louver group in the louver group column 24a would be louver group 24a-2, and so on until reaching louver group 24a-n.

The protective louver covering 10 includes structure complementary to the LED pixel columns 20a-20n, the hole group columns 22a-22n, and the louver group columns 24a-24n. Arrangements of vertically aligned elongated hole columns 26a-26n are included to extend through a planar base 28 of the protective louver covering 10 to accommodate the LED pixel columns 20a-20n and the louver group columns 24a-24n which pass through the planar base 28 when the protective louver covering 10 is in intimate contact with the electronic display module 12. When assembled, geometrically configured horizontally oriented protrusion rows 30a-30n protectively extend outwardly from the planar base 28 and beyond the LED pixel columns 20a-20n and the louver group columns 24a-24n. The relationship and association of the LED pixel columns 20a-20n, the hole group columns 22a-22n, the louver group columns 24a-24n, and the geometrically configured protrusion rows 30a-30n are described later in detail. It is to be appreciated that some of the groups of LED pixel columns 20a-20n, hole group columns 22a-22n, and louver group columns 24a-24n may not include complete sets of three items, particularly those columns shown along and about the edges of the associated structures. Correspondingly, the elongated holes of the elongated hole columns 26a-26n and the protrusions in the protrusion rows 30a-30n of the protective louver covering 10 may not be complete structures, particularly those shown along and about the edges of the associated structures. Also shown are a plurality of vertically aligned slits 32a-32n extending along the face of the protective louver covering 10 to simulate seams formed between multiple electronic display module 12 boundaries, thereby making the seams less noticeable to the viewer.

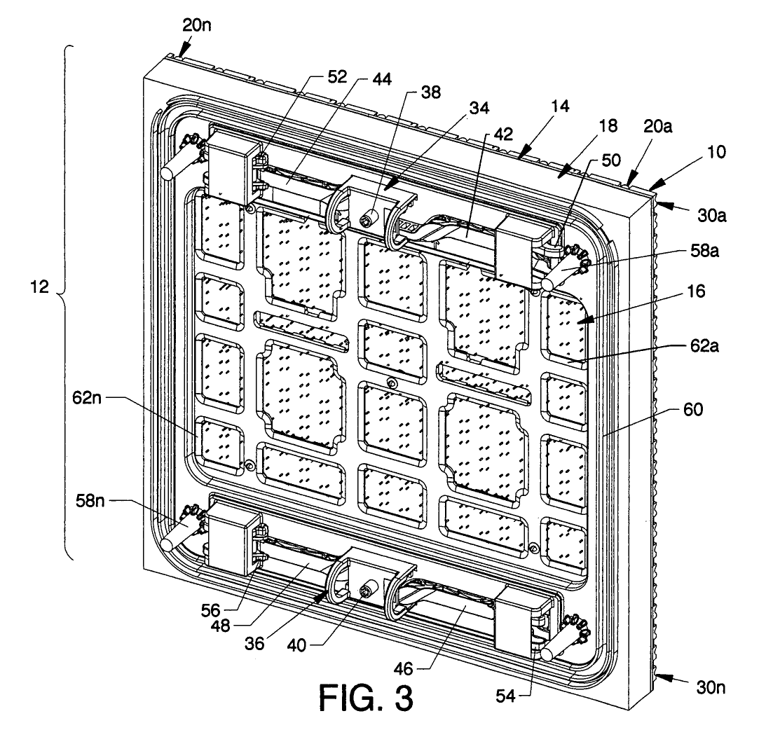

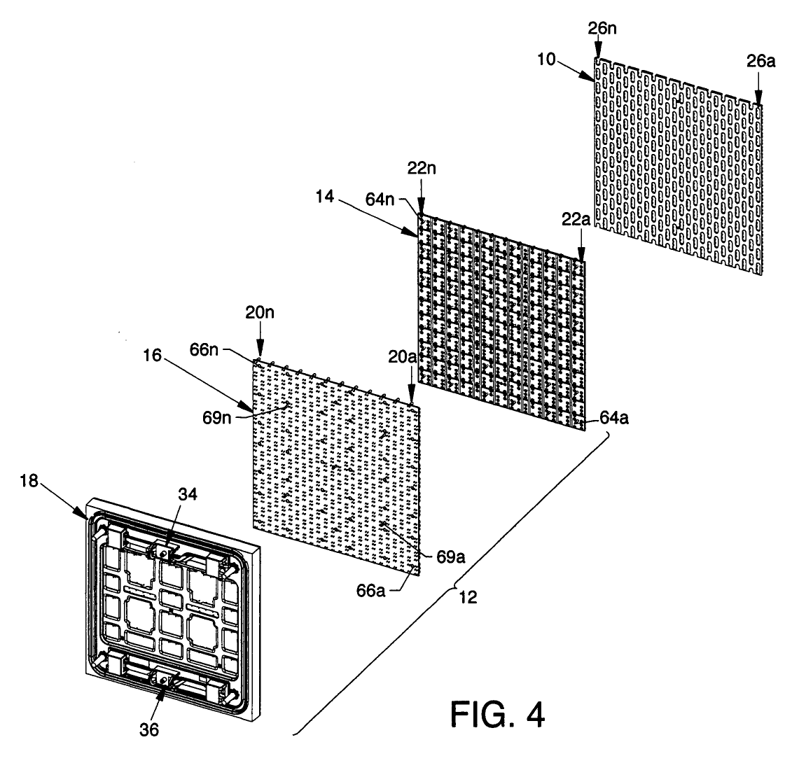

FIG. 3 is an isometric rear view of the electronic display module 12 having a protective louver covering 10 overmoldingly applied to the louver panel 14, and FIG. 4 is an isometric rear view of the protective louver covering 10 and an exploded isometric rear view of the electronic display module 12. Some major components and features of the housing 18 are briefly referenced and include, but are not limited to, opposed latching systems 34 and 36 having actuators 38 and 40, opposed actuator arms 42 and 44, opposed actuator arms 46 and 48, opposed latching mechanisms 50 and 52, and opposed latching mechanisms 54 and 56, incorporated respectively for attachment of the invention to the structure of an electronic sign display. Also included are locator posts 58a-58n, a seal 60, and a plurality of access holes 62a-62n along and about the structure of the housing 18. In the alternative, a driver board (not shown) may be attached to the rear of the housing 18. Also included (FIG. 4) are louver attachment pins 64a-64n extending rearwardly from the louver panel 14 for accommodation by a plurality of alignment holes 66a-66n in the LED panel 16 and by a plurality of forward facing receptor holes 68a-68n in the housing 18 (FIG. 2). A plurality of rearwardly directed latch pins 69a-69n extend from the LED panel 16 to engage the housing 18.

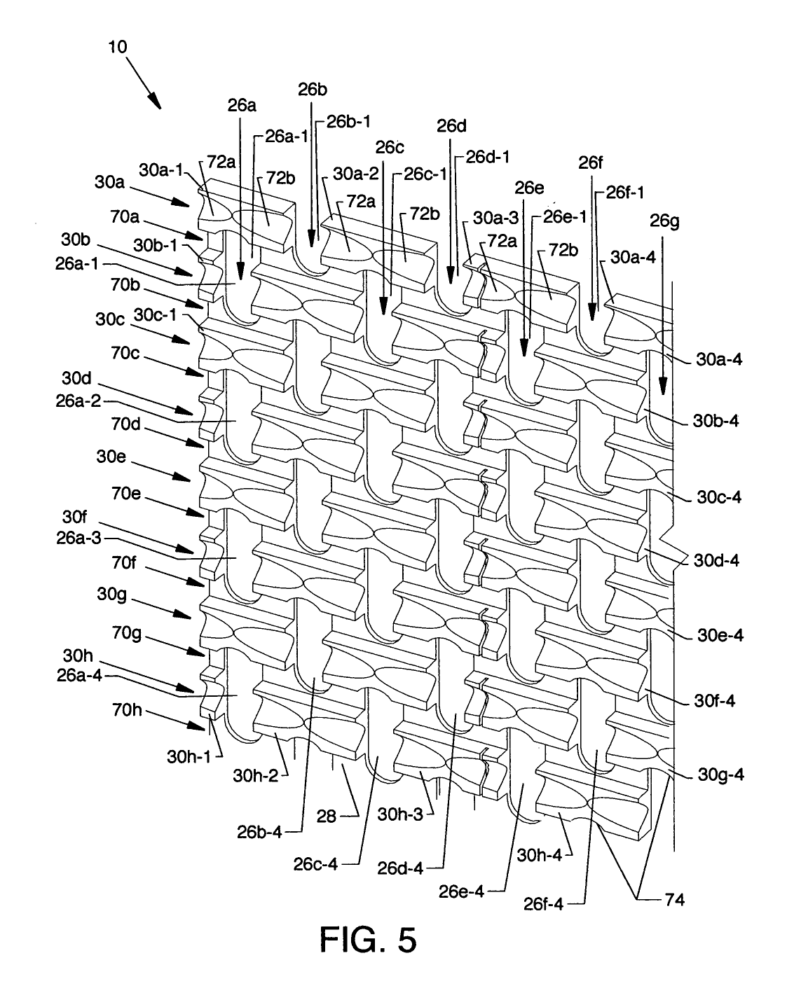

FIG. 5 is an isometric front view of a section of the protective louver covering 10 showing the structure and geometric configuration thereof, including the planar base 28, the protrusion rows 30a-30h extending outwardly from the planar base 28, and the elongated hole columns 26a-26g extending through the planar base 28. The elongated hole columns 26a-26n and the protrusion rows 30a-30n are arranged in a staggered grid matrix configuration. Alternating columns of elongated hole columns 26a-26n are staggered with respect to one another. For example, elongated hole columns 26a, 26c and 26e align to each other, and, similarly, elongated hole columns 26b, 26d and 26f align to each other. Further, the aligned elongated hole columns 26a, 26c and 26e, and the aligned elongated hole columns 26b, 26d and 26f align as units to each other in a staggered configuration. The protrusion rows 30a-30n likewise are alternatingly staggered with respect to one another. For example, protrusion rows 30a, 30c and 30e align to each other and protrusion rows 30b, 30d and 30f align to each other. Further, the protrusion rows 30a, 30c and 30e and the protrusion rows 30b, 30d and 30f align as units to each other in a staggered configuration.

The structure of the protective louver covering 10 is designed to accommodate the LED pixel columns 20a-20n and the structure of the louver group columns 24a-24n and to allow viewing of each and every LED of the LED pixel columns 20a-20n from various positions, the columns and rows and relationships thereof now being further designated and described. The elongated holes of the elongated hole columns 26a-26n are further designated and referred to having suffixes to indicate individual elongated holes, whereby the first elongated hole in the elongated hole column 26a would be elongated hole 26a-1, the second elongated hole in the elongated hole column 26a would be elongated hole 26b-1, and so on in the same manner until reaching elongated hole 26n-1. In a like manner, the protrusions of the protrusion rows 30a-30n are further designated and referred to having suffixes to indicate individual protrusions, whereby the first protrusion in the protrusion row 30a would be protrusion 30a-1, the second protrusion in the protrusion row 30a would be protrusion 30a-2, and so on in the same manner until reaching protrusion 30a-n. Additionally, horizontally aligned spaces 70a-70n are included between successive protrusion rows 30a-30n which allow angular viewing of the top and bottom LEDs comprising pixels of the LED pixel columns 20a-20n. Each of the protrusions included in protrusion rows 30a-30n includes opposed angled recesses 72a and 72b having surfaces which are sculpted surfaces allowing angular viewing of each of the center LEDs comprising pixels of the LED pixel columns 20a-20n. The opposed angled recesses 72a and 72b are angled from the general plane of the outer surface of the protrusions of the protrusion rows 30a-30n, the deepest part being toward and forming part of the edges of the adjacent elongated holes of the elongated hole columns 26a-26n. The bottom of each protrusion of the protrusion columns 30a-30n includes an arcuate recess 74 for accommodation of the top LED forming each of the pixels of each of the LED pixel columns 20a-20n. Viewing of the pixels of the LED pixel columns 20a-20n when directly in front of the LED pixel columns 20a-20n, whether at the same level or at a lower level, affords direct viewing of all of the LEDs forming the LED pixel columns 20a-20n, and viewing of the LED pixel columns 20a-20n when off to the side of the LED pixel columns 20a-20n, whether at the same level or at a lower level, also affords direct viewing of all of the LEDs forming the LED pixel columns 20a-20n. Alignment of the LED pixel columns 20a-20n, with features of the louver panel 14 and the protective louver covering 10, is shown in the figures that follow.

FIG. 6 shows is an exploded isometric front view of the upper left corner of the protective louver covering 10, the corresponding upper left corner of the louver panel 14, and the corresponding the upper left corner of the LED panel 16 showing the alignment and relationship of the components thereof.

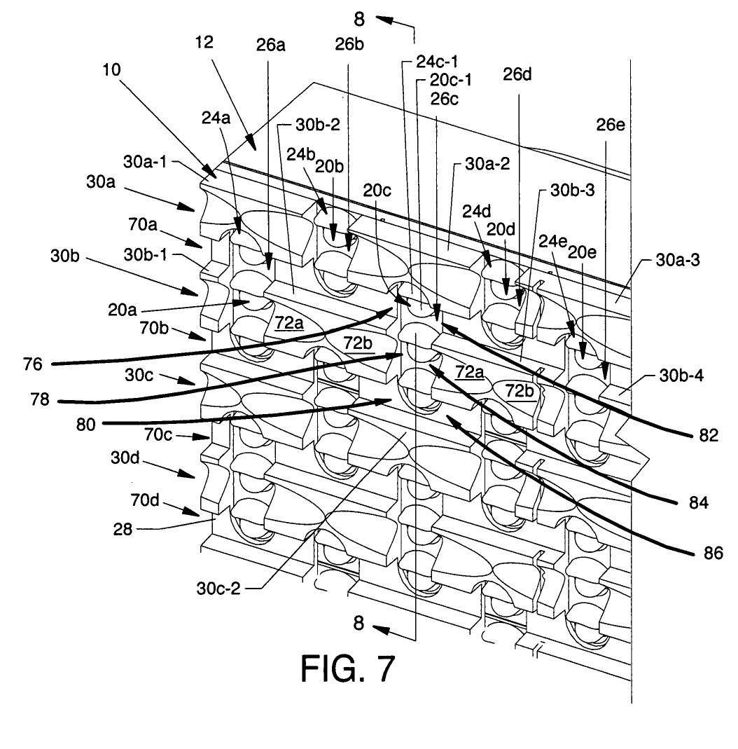

FIG. 7 is an isometric front view of the upper left corner of the protective louver covering 10 in use with the electronic display module 12 showing side view paths. Shown in particular is the relationship of the LED pixel columns 20a-20e of the LED pixel columns 20a-20n and the louver group columns 24a-24e of the louver group columns 24a-24n to the elongated hole columns 26a-26e of the elongated hole columns 26a-26n and the protrusion rows 30a-30d of the protrusion rows 30a-30n, whereby protection to a player and protection of the electronic display module 12 is provided by the protective louver covering 10. Also shown are left viewing paths 76, 78 and 80 and right viewing paths 82, 84 and 86 which are accommodated and afforded by the structure of the protective louver covering 10. More specifically, full viewing from the left and the lower left is made along view paths 76, 78 and 80, whereby the left view path 76 occurs along part of the space 70a adjacent to the uppermost LED of the LED pixel 20c-1 for viewing of the uppermost LED of the LED pixel 20c-1, whereby the left view path 78 occurs along the sculpted surface of the angled recess 72b of the protrusion 30b-2 for viewing of the central LED of the LED pixel 20c-1, and whereby the left view path 80 occurs along part of the space 70b adjacent to the lowermost LED of the LED pixel 20c-1 for viewing of the lowermost LED of the LED pixel 20c-1. Correspondingly, full viewing from the right and the lower right is made along view paths 82, 84 and 86, whereby the right view path 82 occurs along part of the space 70a adjacent to the uppermost LED of the LED pixel 20c-1 for viewing of the uppermost LED of the LED pixel 20c-1, whereby the right view path 84 occurs along the sculpted surface of the angled recess 72a of the protrusion 30b-3 for viewing of the central LED of the LED pixel 20c-1, and whereby the right view path 86 occurs along part of the space 70b adjacent to the lowermost LED of the LED pixel 20c-1 for viewing of the lowermost LED of the LED pixel 20c-1. Additionally, with respect to the vertically aligned centerlines of the LED pixel 20c-1, the left view path 78 affords at least a 70 degree view angle and the right view path 84 affords at least a 70 degree view angle, for a total view and of at least 140 degrees. Of course, viewing of all pixels of the LED pixel 20c-1 from the front is made in a direct and straightforward manner. Viewing of the other LED pixels is accomplished in a corresponding manner.

### MODE OF OPERATION

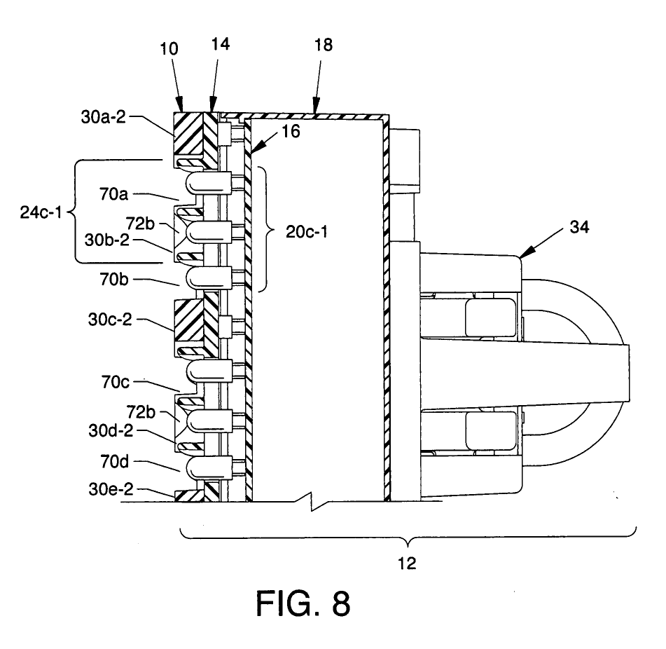

FIG. 8 is a cross section view along line 8-8 of FIG. 7 showing the protective louver covering 10, the present invention, incorporated into use with components of the electronic display module 12. Shown in particular is the protection provided to the LED pixels, such as LED pixel 20c-1, and protection provided to the louver groups, such as louver group 24c-1, which are inset from the outer surface of the protrusions, such as protrusions 30a-2, 30b-2 and 30c-2, as shown, whereby a player or sports object would first encounter the outer surface of the these protrusions or other protrusions, thereby preventing component damaging contact with the components of the electronic display module 12. The thermoplastic elastomer protective louver covering 10 provides protection for the player by the inclusion of the protective louver covering 10 between the player and the electronic display module 12 owing to the inherent properties of the thermoplastic elastomer which make the thermoplastic elastomer material elastic and flexible to provide impact absorbency.

Various modifications can be made to the present invention without departing from the apparent scope thereof.

It is claimed:

1. A thermoplastic elastomer protective louver covering for an outermost surface of a louver panel of an electronic display module, the covering comprising:
a molded body having a planar base with a plurality of elongated holes therethrough to accommodate protruding louvers of the louver panel of the electronic display module and to allow associated pixels of the electronic display module to be viewed therethrough;
a plurality of angled recesses formed in the molded body, each of the angled recesses having a sculpted surface and each of the angled recesses being aligned with an elongated hole of the plurality of elongated holes, and each of the angled recesses allowing viewing of a pixel associated with the elongated hole aligned therewith, wherein the allowed viewing is from an angle relative to the electronic display module when the covering is in place over the outermost surface of the louver panel of the electronic display module; and,
the molded body having a front surface which, when the company is in place over the outermost surface of the louver panel of the electronic display module, will be situated in front of any protruding louver of the louver panel, the front surface providing cushioned protection of a player contacting the front surface.

2. The thermoplastic elastomer protective louver covering of claim 1, wherein the thermoplastic elastomer of the covering is selected from the group of materials consisting of Versaflex (available from The GLS Corp. of McHenry, Ill.) and Tekbond (available from Teknor Apex of Pawtucket, R.I.).

3. The thermoplastic elastomer protective louver covering of claim 1, wherein the thermoplastic material is characterized by player protective impact resistance within a temperature range of about 120° F. to about −20° F.

4. The thermoplastic elastomer protective louver covering of claim 1, wherein the thermoplastic material is characterized by player protective flexibility within a temperature range of about 120° F. to about −20° F.

5. The thermoplastic elastomer protective louver covering of claim 1, wherein the thermoplastic material is characterized by player protective abrasion resistance within a temperature range of about 120° F. to about −20° F.

6. The thermoplastic elastomer protective louver covering of claim 1, wherein the thermoplastic material is opaque.

7. The thermoplastic elastomer protective louver covering of claim 1, wherein the covering is overmolded to the outermost surface of the louver panel.

8. The thermoplastic elastomer protective louver covering of claim 7, wherein the louver panel is overmolded by placing in an overmold tool and thermoplastic elastomer injection molded to form a bonded protective louver covering at an interface upon the louver panel.

9. The thermoplastic elastomer protective louver covering of claim 8, wherein the overmold tool provides the plurality of elongated holes on the thermoplastic elastomer protective louver covering.

10. The thermoplastic elastomer protective louver covering of claim 8, wherein the overmold tool provides the plurality of angled recesses on the thermoplastic elastomer protective louver covering.

11. The thermoplastic elastomer protective louver covering of claim 8, wherein the overmold tool provides the front surface in front of any protruding louvers on the thermoplastic elastomer protective louver covering.

12. The thermoplastic elastomer protective louver covering of claim 8, wherein the louver panel is formed of a hard and rigid plastic, suitable for overmolding, and wherein the overmold tool is cut to precisely fit portions of the louver panel and maintain a configured receptive space at the interface for accepting an injection mold application of the thermoplastic elastomer material thereupon.

13. The thermoplastic elastomer protective louver covering of claim 1, further comprising:
at least two horizontally oriented recessed spaces defining at least one protrusion therebetween, the at least one protrusion bearing a portion of the front surface and having at least one of the angled recesses therein.

14. The thermoplastic elastomer protective louver covering of claim 13, wherein the electronic display module has plural pixels to be viewed, the pixels being arranged in rows and columns, and the covering has the protrusions arranged in rows and columns coordinated with the pixel rows and columns, such that each pixel has an associated protrusion providing a portion of the front surface associated with the pixel.

15. The thermoplastic elastomer protective louver covering of claim 14, wherein each protrusion has a first angled recess allowing viewing of another pixel on a first horizontal side of the protrusion and a second angled recess allowing viewing of another pixel on a second horizontal side of the protrusion, such that pixels may be viewed from horizontal angles of about 70 degrees relative to perpendicular to the viewing surface of the electronic display module and the front surface of the covering, providing thereby a range of about 140 degrees of horizontal viewing.

16. A thermoplastic elastomer protective louver covering comprising:
a planar base with a front face and a rear face;
at least one aperture extending through the planar base; and,
at least two protrusions extending from the front face of the planar base horizontally adjacent the at least one aperture, each of the protrusions having a front surface and an angled recess having a sculpted surface leading to the at least one aperture and affording angled viewing of the at least one aperture.

17. The thermoplastic elastomer protective louver covering of claim 16, wherein each protrusion further includes an arcuate recess substantially centered on a lower edge thereof and an aperture extending through the planar base associated with each arcuate recess.

18. The thermoplastic elastomer protective louver covering of claim 17, wherein the apertures are vertically elongated apertures, each of the vertically elongated apertures being capable of accepting a set of three vertically arranged LEDs and three louvers of an electronic display module.

19. The thermoplastic elastomer protective louver covering of claim 18, wherein the electronic display module is arranged with rows and columns of the set of three vertically arranged LEDs, and the protective louver covering is coordinated with the electronic display module such that the uppermost LED and associated louver of each set of three vertically arranged LEDs are accommodated in the arcuate recess in the lower edge of a protrusion, the middle LED of each horizontally adjacent set of three vertically arranged LEDs is accommodated by one of two angled recesses, and the lowermost LED of each horizontally adjacent set of three vertically arranged LEDs is visible below the protrusion.

20. A method of making a protective louver covering for an electronic display module having LEDs, the method comprising the steps of:
providing a louver panel for subsequent assembly onto the electronic display module, the louver panel including apertures and louvers, the louvers being associated with the apertures and projecting from the louver panel above the apertures, each of the apertures being arranged for accepting an LED of the electronic display module, which LEDs are arranged in sets of three LEDs and organized in rows and columns;
providing an overmold tool closely fitted to portions of the louver panel adjacent to the apertures of the louver panel and accommodating the louvers of the louver panel so as to provide a configured space for receiving injection molded thermoplastic elastomer material to define a planar base with elongated holes surrounding each set of three LED accepting apertures and the louvers associated therewith; and,
injecting molding thermoplastic elastomer material into the configured space so as to bond a thermoplastic elastomer protective louver covering over a desired interface of the louver panel and generate a configured thermoplastic elastomeric protective louver covering thereon.

21. The method of claim 20, further comprising the step of:
removing the louver panel and bonded protective louver covering from the overmold tool.

22. The method of claim 21, wherein the protective louver covering is bonded to an interface at a front surface of the louver panel, thereby defining a planar base of the protective louver covering with elongated holes surrounding and preserving sets of three LED accommodating apertures and associated louvers.

23. The method of claim 22, wherein the apertures of the louver panel are preserved and surrounded by elongated holes and the protective louver covering bonded to the louver panel includes a planar base and protrusions from the planar base having a protective relationship with the louvers projecting from the louver panel.

24. The method of claim 23, wherein the protrusions include angled recesses having sculpted surfaces generated by the configured space of the overmold tool, for allowing angled horizontal viewing of the electronic display module.

25. The method of claim 24, wherein each protrusion includes two angled recesses having sculpted surfaces, such that angled horizontal viewing of LEDs in elongated holes on either side of a protrusion may be viewed through a viewing path at a horizontal viewing angle of up to about 70 degrees, such that a horizontal viewing range of about 140 degrees is retained.

26. An overmold tool for forming a protective covering on a louver panel for an electronic display module, the louver panel having apertures and louvers, the overmold tool comprising:
means for aligned close fitting of an elongate seal about sets of three LED accommodating apertures and associated louvers of the louver panel;
a configured space interfacing on the louvered panel so as to define a planar base for the protective covering and protrusions from the planar base; and,
an inlet for injection molding of thermoplastic elastomeric material into the configured space.

27. The overmold tool of claim 26, wherein the protrusions resulting from the configured space of the overmold tool include two angled recesses having sculpted surfaces, each of the angled recesses having sculpted surfaces being associated with an aperture adjacent the protrusion and the two angled recesses having sculpted surfaces together defining a left view path and a right view path for viewing the accommodated LEDs of the electronic display module behind a protective covered louver panel resulting from overmolding with the overmold tool.

28. The overmold tool of claim 26, wherein the elongated holes in the planar base accommodate three vertically arranged LED accommodating apertures of the louver panel, and the elongated holes are arranged in rows and columns, each elongated hole having an associated protrusion in the protective covering, each associated protrusion defining a right and left view path for viewing LEDs situated right and left of the protrusion.

29. An electronic display louver panel and covering for an electronic display module, the louver panel and covering comprising:
a louver panel having sets of three LED accommodating holes and louvers associated with each of the three LED accommodating holes; and,
the covering having a planar base bonded to the louver panel, an elongate hole surrounding each set of three LED accommodating holes and associated louvers, and a protrusion associated with each elongate hole, which protrusion extends past the louvers to protect an impacting player from contact with the louvers.

30. The louver panel and covering of claim 29, wherein each protrusion includes an angled recess having a sculpted surface allowing a horizontal viewing path to the left and an angled recess having a sculpted surface allowing a horizontal viewing path to the right such that adjacent LED accommodating holes may be viewed.

31. The louver panel and covering of claim 29, wherein each protrusion includes an arcuate recess for viewing a top LED of a set of three LEDs.

32. The louver panel and covering of claim 29, wherein the louver panel is formed of rigid plastic and the covering is formed of thermoplastic elastomer material.

33. The louver panel and covering of claim 32, wherein the thermoplastic elastomer covering is bonded to the rigid plastic louver panel.

34. The louver panel and covering of claim 33, wherein the bonding results from overmolding the covering upon the panel.

35. The louver panel and covering of claim 34, wherein the overmolding formed the protrusions on the covering.

36. The louver panel and covering of claim 35, wherein the covering is effective in protecting players from the louvers from about 120° F. to about −20° F.

37. The louver panel and covering of claim 35, further comprising slits in the covering simulating seams between panels so as to obscure true seams between panels.

38. The louver panel and covering of claim 37, wherein the slits are vertically aligned in the covering.

39. The louver panel and covering of claim 29, wherein the elongated holes are arranged in columns and the protrusions are arranged in rows and the row and columns are in staggered grid matrix configuration.

40. The louver panel and covering of claim 39, wherein the protrusions are separated by horizontally aligned spaces between successive protrusion rows so as to allow angular viewing of the top and bottom LEDs of sets of three LEDs.
